(19) United States
(12) Patent Application Publication
(10) Pub. No.: US 2007/0107404 A1
(43) Pub. Date: May 17, 2007

(54) HEIGHT ADJUSTMENT SYSTEM FOR A LAWN MAINTENANCE DEVICE

(75) Inventors: Ronald J. Hickenbottom, Sullivan, IL (US); Anthony Todd, Sullivan, IL (US)

Correspondence Address: VEDDER PRICE KAUFMAN & KAMMHOLZ, 222 N. LASALLE STREET, CHICAGO, IL, 60601, US

(73) Assignee: AGRI-FAB, INC., Sullivan, IL (US)

(21) Appl. No.: 11/163,922

(22) Filed: Nov. 3, 2005

(51) Int. Cl. A01D 34/00

(52) U.S. Cl. 56/17.2

(57) ABSTRACT

A lawn maintenance device including a body with opposed side walls, an axle rotatably mounted to each of the side walls and a pair of height adjustment brackets, each rotatably mounted to one of the sidewalls. Each bracket includes a first end engaging a front portion of the sidewall and traverses relative to a first arcuate slot, a second end portion disposed relative to a rear portion of the sidewall to traverse relative to a second arcuate slot, the second end portion engages the sidewall to prevent unintended rotation of the bracket, and a pivot portion located between the first end portion and the second end portion and connected to an end of the axle. Each wheel is mounted to the first end portion of a bracket and coupled to an end of the axle such that rotation of each wheel rotates the axle and rotation of each of the brackets about the sidewalls moves the wheel relative to the body to adjust the body with respect to the ground.

### FIELD OF THE DISCLOSURE

The present disclosure generally related to lawn maintenance devices, and more particularly, to a height adjustment system for a lawn maintenance device.

### BACKGROUND

Typically, the left and right hand drive wheels of conventional lawn sweepers are connected by a tube or bar that allows a user to adjust the brush height by a single lever located between the wheels. Disadvantages of this conventional configuration include increased costs, due to the number of parts and difficulty in operation when parts begin to wear and bind. Additionally, other lawn implements have incorporated height adjustment mechanisms at each wheel. However, such implements do not address the particular requirements of lawn sweepers in that the ground engaging wheels of a lawn sweeper must drive the brush that extends between the wheels. Accordingly, conventional lawn sweepers have been configured as described above and independent side-to-side adjustment has been unsuccessful due to issues of binding and misalignment with respect to drive mechanisms. Consequently, the teachings and suggestions of other lawn implements are inapplicable to lawn sweepers.

Therefore, there exists a need in the art for a lawn sweeper brush height adjustment that is independent from side-to-side and overcomes disadvantages described above but also uses less material, is easier to assemble and is less costly and provides improved performance in use.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 illustrates a side view of a lawn maintenance device having a height adjustment mechanism in accordance with the teachings of the present disclosure;

FIG. 2 illustrates an exploded perspective view of the height adjustment mechanism of FIG. 1;

FIG. 3 illustrates a perspective fragmentary view of a side portion of the lawn maintenance device of FIG. 1; and

FIG. 4 illustrates a perspective bottom view of the lawn maintenance device of FIG. 1.

### DETAILED DESCRIPTION

For the purposes of promoting and understanding the principles disclosed herein, reference will now be made to the preferred embodiments illustrated in the drawings and specific language will be used to describe the same. It will nevertheless be understood that no limitation of the scope is thereby intended. Such alterations and further modifications in the illustrated device and such further applications are the principles disclosed as illustrated therein as being contemplated as would normally occur to one skilled in the art to which this disclosure relates.

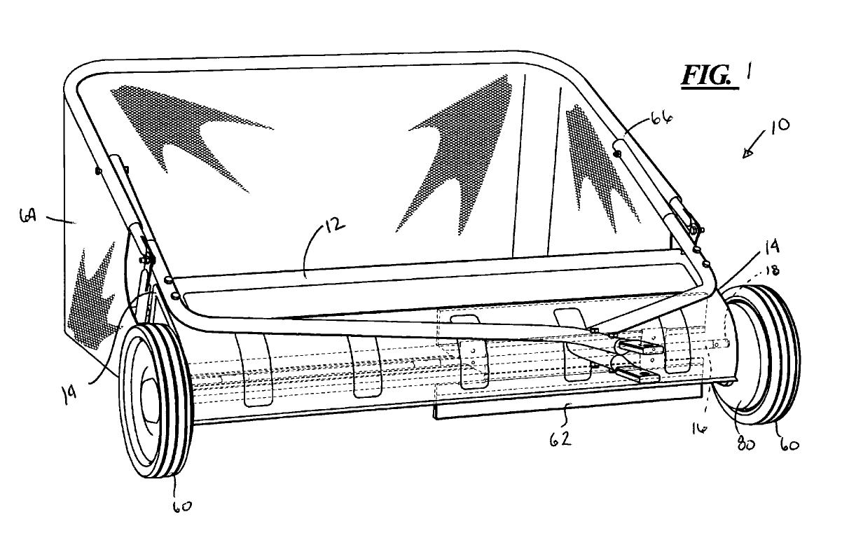

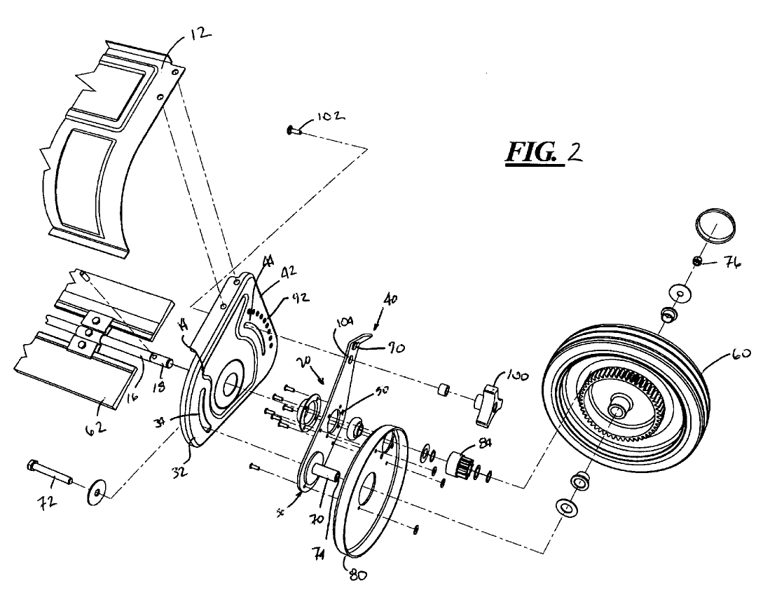

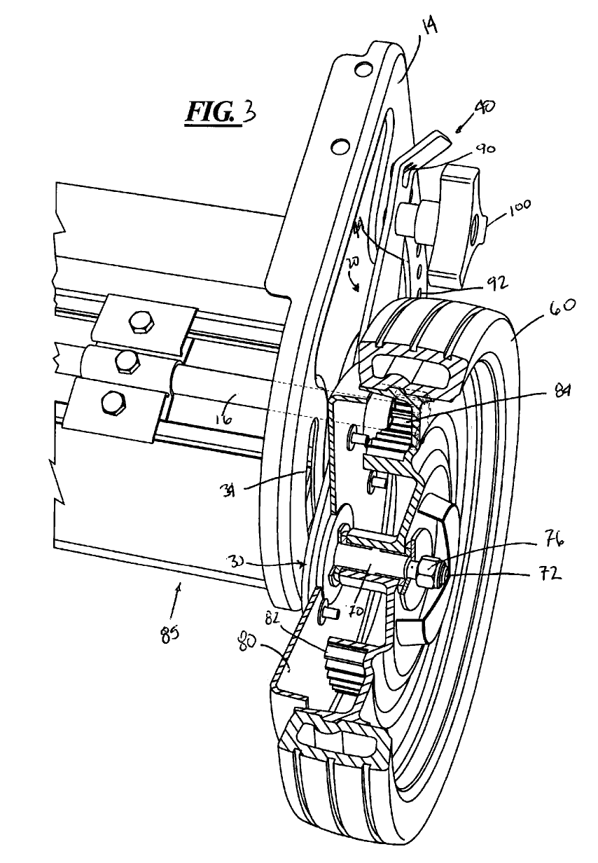

Referring to FIG. 1, a lawn maintenance device 10 constructed in accordance with the teachings of the present disclosure is shown. The lawn maintenance device 10 includes a body 12 having a pair of opposed sidewalls 14. An axle 16 is housed in the body 12 such that each end 18 of the axle 16 is rotatably mounted to a corresponding sidewall 14. The lawn maintenance device 10 also includes a pair of height adjustment brackets 20 (as shown in FIGS. 2 and 3). Each height adjustment bracket 20 is rotatably mounted to a corresponding sidewall 14.

Referring to FIG. 2, each bracket 20 includes a first end portion 30 that engages a front portion 32 of the sidewall 14. The front portion 32 of the sidewall 14 includes a first arcuate slot 34, relative to which the first end portion 30 of the bracket 20 traverses. The bracket 20 also includes a second end portion 40 that is disposed relative to a rear portion 42 of the sidewall 14. The sidewall 14 includes a second arcuate slot 44 disposed in the rear portion 42. The second end portion 40 of the bracket 20 traverses relative to the second arcuate slot 44. The second end portion 40 of the bracket 20 can also engage the sidewall 14 to prevent unintended rotation of the bracket 20 relative to the sidewall 14. The bracket 20 also includes a pivot portion 50 located between the first end portion 30 and the second end portion 40. The pivot portion 50 is rotatably connected to a corresponding end 18 of the axle 16. The lawn maintenance device 10 may also include a pair of wheels 60, with each wheel being rotatably mounted to the first end portion 30 of the corresponding bracket 20. Each wheel 60 is operatively coupled to a corresponding end 18 of the axle 16. Accordingly, rotation of each wheel 60 rotates the axle 16. The height of the body 12 from the ground can be adjusted by rotation of each of the brackets 20 relative to the corresponding sidewall 14 about the pivot portion 50.

The lawn maintenance device 10 may be any type of device that is commonly used to provide lawn and general landscaping functions. For example, the lawn maintenance device 10 may be a lawn mower such that the axle 16 is connected to plurality of lawn cutting blades (not shown) so that when the lawn maintenance device 10 is pushed or pulled forward the wheels 60 rotate the axle 16 to cut the lawn. In another example, the lawn maintenance device 10 may be a lawn sweeper, such that the axle 16 is connected to a plurality of sweeper blades 62. Accordingly, when the lawn maintenance device 10 is pushed or pulled forward, the sweeper blades 62 can sweep leaves or other debris off the lawn and push or pull the collected debris into a catch bag 64 that may be mounted to the body 12 at the rear portion of the lawn maintenance device 10. In the examples disclosed herein, the lawn maintenance device 10 will be described as a lawn sweeper. However, one of ordinary skill in the art will appreciate that the lawn maintenance device 10 may be any type of lawn or landscaping device such as a lawn mower, a fertilizer spreader, an aerator, a thatcher or the like.

With typical lawn maintenance devices, regardless of what type of function it provides, a user may push or pull the lawn maintenance device 10 with a handle 66 so that the wheels 60 rotate to thereby rotate the axle 16 to perform the function that is derived by the rotation of the axle 16. However, in most lawn maintenance devices 10, it may be necessary to adjust the height of the body 12 relative to the ground to change the degree of functionality that is provided by the lawn maintenance device 10. For instance, in a lawn mower, the height of the body 12 relative to the ground determines the height of the grass that is cut from the lawn. When the lawn maintenance 10 is a lawn sweeper as illustrated and described herein, the height of the body 12 relative to the ground may determine the number and size of the leaves and other debris that can be collected by the lawn sweeper. Accordingly, the brackets 20 and their associated components that will be described in detail herein, provide height adjustment of the body 12 relative to the ground.

Referring to FIG. 2, the first end portion 30 of the bracket 20 includes a spindle 70 on which a corresponding wheel 60 is mounted. Accordingly, the wheel 60 rotates on the spindle 70. The wheel 60 is maintained on the spindle 70 by a bolt 72 that engages a bore 74 of the spindle 70 from the inside of the sidewall 14 through the first arcuate slot 34. A nut 76 is fastened to the end of the bolt 72 to maintain the wheel 60 on the spindle 70, while allowing the wheel 60 to spin relative to the spindle 70. Additionally, the bolt 72 and the nut 76 provide for the first end portion 30 of the bracket 20 to traverse along the first arcuate slot 34, while preventing the first end portion 30 from disengaging from the first arcuate slot 34. Therefore, the first end portion 30 of the bracket 20 traverses along the first arcuate slot 34 while being maintained within the path defined by the first arcuate slot 34. Accordingly, when the first end portion 30 is moved along the arcuate slot 34, the position of the wheel 60 relative to the body 12 changes such that if the wheel 60 is contacting the ground, the body 12 can be lowered or raised relative to the ground.

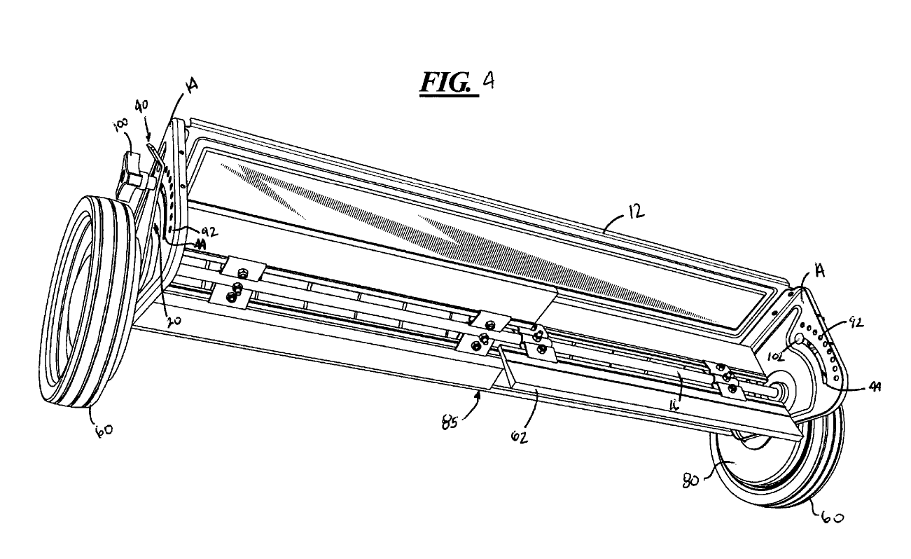

Referring to FIGS. 3 and 4, the wheel 60 includes a wheel housing 80, in which a wheel gear 82 and an axle gear 84 are housed. The wheel gear 82 is concentric with the wheel 60 and is rotationally mounted on the spindle 70. Accordingly, the wheel 60 and the wheel gear 82 rotate relative to the spindle 70 while mounted on the spindle 70. The axle gear 84 is fixedly attached to the end of the axle that protrudes from the sidewall 14 and is housed in the wheel housing 80. The wheel gear 82 is coupled to the axle gear 84 in such a manner that rotation of the wheel gear 82 will rotate the axle gear 84 only in one desired direction. Therefore when the lawn maintenance device 10 is pushed or pulled such that the wheel 60 turns, the wheel gear 82 rotates thereby causing the rotation of the axle gear 84, which will rotate to axle 16 to provide the function that is provided by the lawn maintenance device 10, i.e., rotating the lawn sweeper blades 85.

As discussed in the foregoing, the wheel 60, including the wheel housing 80 is movable along the first arcuate slot 34 so as to raise and lower the body 12 relative to the ground. Accordingly, the wheel 60 including the wheel housing 80 can traverse along the first arcuate slot 34 without affecting the aforementioned coupling between the wheel gear 82 and the axle gear 84. The axle 16 protrudes from the sidewall 14 through the pivot portion 50 of the bracket 20 and through the wheel housing 80 as described above. Axle gear 84 is then fixedly attached to the end of the axle 16, which terminates inside the wheel housing 80. Therefore the bracket 20 is pivotally mounted on the sidewall 14 by the pivot portion 50 being rotationally mounted on the axle 16.

The second end portion 40 of the bracket 20 enables an operator of the lawn maintenance device 10 to adjust the height of the body 12 relative to the ground. Accordingly, the second end portion 40 simply functions as a handle so that an operator can move the first end portion 30 of the bracket 20 along the first arcuate slot 30 to adjusted height of the body 12 relative to the ground. To maintain the height of the body 12 relative to the ground once the height is adjusted to a desired level, the second end portion 40 includes a protrusion 90 facing the sidewall 14. A plurality of apertures 92 are disposed at the rear portion 42 of the sidewall 14 in an arc to correspond with the arc that the protrusion 90 of the second end portion 40 traces along the sidewall 14 when the bracket 20 is pivoted about the axle 16. The apertures 92 may be disposed in equal distances from each other such as to provide discreet and equal height variations for the body relative to the ground. The apertures 92 are sized so as to receive the protrusion 90 when the protrusion 90 is aligned with any one of the apertures 92. To remove the protrusion 90 from an aperture 92 to adjust the height of the body relative to the ground, the second end portion 40 of the bracket 20 can be pulled outward relative to the sidewall 14 by the operator, so that the protrusion 90 disengages from the aperture 92. The operator can then pivot the bracket 20 about the pivot portion 50, i.e. about the axle 16, to align the protrusion 90 with another one of the apertures 92. Once the protrusion 90 is aligned with another aperture 92, the operator can release the second end portion 40 thereby causing the protrusion 90 to engage the aperture 92. However, to maintain the protrusion 90 engaged with an aperture 92 after the height of the body 12 is adjusted relative to the ground, the bracket 20 includes a locking knob 100 that engages a screw 102 through an aperture 104 in the second end portion 40. The screw is mounted from the inside of the sidewall 14 through the second arcuate slot 44 and through the aperture 104 thereby allowing the locking knob to be tightened to the end thereof. Therefore by tightening the locking knob 100, the second end portion 40 can be securely maintained at a desired position along the second arcuate slot 44 once the height of the body 12 is adjusted relative to the ground. Additionally, the locking knob 100 and the screw 102 ensure that the second end portion 40 of the bracket 20 traverses within the second arcuate slot 44 while preventing the second end portion 40 to disengage from the second arcuate slot 44.

As described in the foregoing, an operator can move the second end portion 40 of the bracket 20 along the second arcuate slot 44 and cause the pivoting of the bracket 20 about the axle 16, thereby moving the first end portion 30 along the first arcuate slot 34 to adjust the height of the body 12 relative to the ground. Therefore, the height of the body 12 relative to the ground can be adjusted through a height that is defined by the range of motion of the first end portion 30 and the second end portion 40 through the first arcuate slot 34 and the second arcuate slot 44, respectively. The bracket 20 and the above-described associated mechanisms, provide for adjustment of the height of the body 12 relative to the ground without disturbing the drive mechanism by which the wheel 60 can drive the axle 16 to operate the lawn maintenance device 10. Furthermore, the bracket 20 and its associated mechanisms maintain the adjusted height of the body 12 relative to the ground by engagement of the protrusion 90 with the plurality of apertures 92 and engagement of the locking knob 100 and the screw 102 with the second arcuate slot 44. Additionally, the engagement of the protrusion 90 with the apertures 92 allow an operator to simply adjust the height of the body 12 relative to the ground by rotating the second end portion 40 of the bracket 20 along the second arcuate slot 44 through the discreet height variations provided by the apertures 92.

Furthermore, while the particular preferred embodiments have been shown and described, it will be obvious to those skilled in the art that changes and modifications may be made without departing from the teaching of the disclosure. The matter set forth in the foregoing description and accompanying drawings is offered by way of illustration only and not as limitation. The actual scope of the disclosure is intended to be defined in the following claims when viewed in their proper perspective based on the related art.

What is claimed is:

1. A lawn maintenance device comprising:
a body having a pair of opposed side walls;
an axle having each end thereof rotatably mounted to a corresponding one of the side walls;
a pair of height adjustment brackets, each height adjustment bracket rotatably mounted to a corresponding one of the sidewalls and comprising:
a first end portion operatively engaging a front portion of the sidewall and adapted to traverse relative to a first arcuate slot defined in the front portion;
a second end portion disposed relative to a rear portion of the sidewall and adapted to traverse relative to a second arcuate slot defined in the rear portion of the sidewall, the second end portion adapted to engage the sidewall to prevent unintended rotating of the bracket relative to the sidewall; and
a pivot portion located between the first end portion and the second end portion and rotatably connected to a corresponding end of the axle;
a pair of wheels, each wheel being rotatably mounted to the first end portion of a corresponding bracket, each wheel rotationally coupled to a corresponding end of the axle such that rotation of each wheel rotates the axle;
wherein rotation of each of the brackets about the sidewalls at the corresponding pivot portion moves the corresponding wheel relative to the body to adjust the height of the body from the ground.

2. The lawn maintenance device of claim 1, further comprising a plurality of apertures defined in the rear portion of each side wall and aligned with the second arcuate slot, wherein the second end portion of the bracket includes a protrusion that is adapted to engage any one of the apertures.

3. The lawn maintenance device of claim 1, wherein the second end portion of the bracket includes a bracket aperture aligned with the second arcuate slot, and comprising a locking knob adapted to engage the bracket aperture and the second arcuate slot to secure the second end portion of the bracket to the sidewall.

4. The lawn maintenance device of claim 1, wherein the first end portion of the bracket includes a spindle on which the corresponding wheel is rotationally mounted.

5. The lawn maintenance device of claim 1, wherein each wheel includes a hub gear that is adapted to engage a drive gear operatively coupled to a corresponding end of the axle.

6. The lawn maintenance device of claim 1, wherein the axle is operatively coupled to at least one sweeper blade.

7. The lawn maintenance device of claim 1, wherein the axle is operatively coupled to at least one lawn cutting blade.

8. A lawn maintenance device comprising:
a body;
an axle disposed in the body and having the ends thereof rotatably mounted to the body;
a pair of wheels operatively coupled to each axle such that rotation of each wheel provides rotation of the axle;
a pair of brackets, each bracket comprising:
a first end portion operatively engaging a front portion of the body and adapted to traverse relative to a first arcuate slot defined in the front portion;
a second end portion disposed relative a rear portion of the body and adapted to traverse relative to a second arcuate slot defined in the rear portion, the second end portion adapted to engage the body to prevent unintended rotating of the bracket relative to the body; and
wherein the bracket is rotationally coupled to the corresponding end of the axle between the first end portion and the second end portion; and
wherein rotation of each of the brackets about the body moves the corresponding wheel relative to the body to adjust the height of the body from the ground.

9. The lawn maintenance device of claim 8, further comprising a plurality of apertures defined in the rear portion of the body and aligned with the second arcuate slot, wherein the second end portion of the bracket includes a protrusion that is adapted to engage any one of the apertures.

10. The lawn maintenance device of claim 8, wherein the second end portion of the bracket includes a bracket aperture aligned with the second arcuate slot, and comprising a locking knob adapted to engage the bracket aperture and the second arcuate slot to secure the second end portion of the bracket to the body.

11. The lawn maintenance device of claim 8, wherein the first end portion of the bracket includes a spindle on which the corresponding wheel is rotationally mounted.

12. The lawn maintenance device of claim 8, wherein each wheel includes a hub gear that is adapted to engage a drive gear operatively coupled to a corresponding end of the axle.

13. The lawn maintenance device of claim 8, wherein the axle is operatively coupled to at least one sweeper blade.

14. The lawn maintenance device of claim 8, wherein the axle is operatively coupled to at least one lawn cutting blade.

15. An apparatus for adjusting the height of a lawn maintenance device having a body and an axle rotatably and transversely mounted to the body and a pair of wheels, the apparatus comprising:
a pair of brackets, each bracket comprising:
a first end portion operatively engaging a front portion of the body and adapted to traverse relative to a first arcuate slot defined in the front portion;
a second end portion disposed relative a rear portion of the body and adapted to traverse relative to a second arcuate slot defined in the rear portion, the second end portion adapted to engage the body to prevent unintended rotating of the bracket relative to the body; and
wherein the bracket is rotationally coupled to the corresponding end of the axle between the first end portion and the second end portion; and
wherein rotation of each of the brackets about the body moves the corresponding wheel relative to the body to adjust the height of the body from the ground.

16. The apparatus of claim 15, wherein the second end portion of the bracket comprises a protrusion that is adapted to engage any one of a plurality of apertures with the arcuate slot at the rear portion of the body.

17. The apparatus of claim 15, wherein the second end portion of the bracket includes a bracket aperture aligned with the second arcuate slot, and comprising a locking knob adapted to engage the bracket aperture and the second arcuate slot to secure the second end portion of the bracket to the sidewall.

18. The apparatus of claim 15, wherein the first end portion of the bracket includes a spindle on which the corresponding wheel is rotationally mounted.
